(19) United States
(12) Patent Application Publication
(10) Pub. No.: US 2025/0005359 A1
(43) Pub. Date: Jan. 2, 2025

(54) HUMAN-ARTIFICIAL INTELLIGENCE (AI) INTERACTION METHOD AND SYSTEM BASED ON LARGE LANGUAGE MODEL (LLM)

(71) Applicant: Ziyan YANG, Fuzhou (CN)

(72) Inventor: Ziyan YANG, Fuzhou (CN)

(21) Appl. No.: 18/885,028

(22) Filed: Sep. 13, 2024

Related U.S. Application Data
(63) Continuation of application No. PCT/CN2023/129237, filed on Nov. 2, 2023.

(30) Foreign Application Priority Data
Mar. 30, 2023 (CN) 202310328971.8

(51) Int. Cl. G06N 3/08

(52) U.S. Cl. CPC G06N 3/08

(57) ABSTRACT

A human-artificial intelligence (AI) interaction method based on large language model (LLM) is provided. Pre-management is performed on domain-specific information. When receiving a user problem or a user request, the user question or the user request is preprocessed. The domain-specific information is added to a retrieval scope for retrieval to find an information fragment that is most similar to the user problem or the user request. The information fragment is processed as required to obtained a processed information fragment, and the processed information fragment is taken as the context information of the user problem or the user request. The context information and problem information are transmitted to the LLM for processing according to a LLM interface usage method or requirements. A human-AI interaction system includes a pre-managing module, a problem preprocessing module, a retrieval module, an information fragment processing module, and a transmitting module.

### CROSS-REFERENCE TO RELATED APPLICATIONS

This application is a continuation of International Patent Application No. PCT/CN2023/129237, filed on Nov. 2, 2023, which claims the benefit of priority from Chinese Patent Application No. 202310328971.8, filed on Mar. 30, 2023. The content of the aforementioned application, including any intervening amendments thereto, is incorporated herein by reference in its entirety.

### TECHNICAL FIELD

This application relates to human-artificial intelligence (AI) interaction, and more specifically to a human-AI method and system based on large language model (LLM).

### BACKGROUND

LLM (Large Language Model) is a language interaction model based on large-scale labeled data training, and provides a new type of textual interaction interface for product access, so that users can interact with questions and answers in colloquial. It can be widely used in human-artificial intelligent (AI) interaction products, such as, intelligent customer service robots, online documents (e.g., documents, forms, e-mails, minutes of meeting, schedules, and to-do lists) editing assistants, and software intelligent assistants.

When using the above human-AI interaction products, users have to supplement the background of the question and ask questions in the form of similar text templates (i.e., a template of historical data dialog background and query input) in the first inquiry, and constantly supplement the content of the previous dialog as a second or subsequent dialog background for question expansion to obtain better feedbacks.

(i) When users engage in a human-AI dialog with an intelligent customer service robot, in the first inquiry, they have to supplement the inquiry background, i.e., questioning with a text template similar to the subordinate as: “you are an expert/customer service personnel of [such-and-such a business], please provide a possible solution to the following problem [the content of the problem]”; and in the second and subsequent dialogues, they need to supplement the viewpoints for questioning, i.e., a further step-by-step explanation on “as an expert/customer service personnel of [such-and-such the business] and [the solution] to [the problem].

(ii) When users engage in a human-AI dialog with an online document editing assistant, in the first inquiry, they have to supplement the inquiry background, i.e., questioning with a text template similar to the subordinate as: “you are a [profession/position], I sent you an email, [content of the email], and you have to reply to this email”; and in the second and subsequent dialogues, they need to supplement the viewpoints for questioning, for example: “as an expert in [such-and-such field] and outline supplement for [a point of view] in the email”.

(iii) When users engage in a human-AI dialog with an online document editing assistant, in the first inquiry, they have to supplement the inquiry background, i.e., questioning with a text template similar to the subordinate as: “you are [industry] of the [position/station], and now there is a spreadsheet, [field 1, field 2, field 3 . . . ], [some fields] of the spreadsheet are needed to be visually displayed to output [legend]”; and in the second and subsequent dialogues, they need to supplement the viewpoints for questioning, for example: “the output [legend] has [certain issues], which are needed to be adjusted”.

Meanwhile, to realize convenient, multi-round, and communication under the same context, the existing human-AI interaction products have at least one of the following defects:

(i) LLM has limitations on the number of interface tokens (the smallest text unit that can be processed in the model). Taking chatgpt as an example, its current maximum token number is 4096. The limitations of LLM on token size are based on balanced considerations of model performance and service.

(ii) LLM requires users to supplement contextual information to obtain better data.

(iii) LLM has a limit on the maximum number of words for contextual memory, and the earliest conversation will be removed if the accumulated conversations exceed the limit.

(iv) To bypass the above limitations, users are required to manage the interaction context information reasonably by themselves, including context recording, sub-point interactions totaling and disassembling, or summarization of the original conversations in stages and re-inputting the summarization as contexts, but it will lead to compression of the information, which is detrimental to the information.

The above limitations are due to the following defects of the existing LLM.

### (1) Stateless Properties of LLM

The LLM is stateless, which means that each incoming query is processed independently from other interactions. Stateless interactions require memory management, such as interactions using the template of {dialog background} and {query input}.

### (2) Long Context Limitations

The LLM is characterized by the need to process tokens, and the model needs to balance the token size (vocabulary) with computing and storage resources, so the number of tokens is limited, which is not friendly to long contexts.

### (3) Timeliness of Model Data

The LLM is based on data pre-training, and the feedback information is timeliness, that is, the training data is the information before some specific years, and the information generated by the training data is not involved in the training, resulting in inaccurate information feedback from the model.

### (4) Limitations of the Model Data

When the LLM is used to ask for domain-specific information (i.e., information that is not covered by the LLM training data, such as internal process mechanism of the company, specifications, manuals, product introductions, development content, and other private domain information), the LLM cannot give accurate answers. For example, when users have requirements for tabular document processing, the current LLM cannot process the specific document content based on the training data (the data may contain software editing and usage information) because its feedback content is limited to document editing.

### (5) Problems of Long Dialogue Rounds and Cold Starts

For questioning and answering of domain-specific information (i.e., information not covered by LLM training data, such as private domain information, e.g., internal process mechanisms, specifications, manuals, product introductions and development content), it requires multiple rounds of dialogue to obtain more accurate feedback, and supplement the context to solve the cold start problem.

### SUMMARY

The present disclosure provides a human-artificial intelligence (AI) interaction method and system based on large language model (LLM). By using this, when the training data of the LLM does not involve domain-specific information, the relevant context information (also called auxiliary information) can be automatically supplemented for the user, and the context information and the problem information are transmitted to the LLM line for use, so as to solve the problems such as the limitation of long context, the timeliness and the limitations of model data, and the cold start.

In a first aspect, this application provides a human-intelligent interaction method based on LLM, comprising:
(S1) performing pre-management on domain-specific information, wherein the domain-specific information is not covered by training data of the LLM;
(S2) when receiving a user problem or a user request, preprocessing the user question or the user request, wherein the user problem or the user request refers to a user problem or a user request without context-before information;
(S3) adding the domain-specific information to a retrieval scope for retrieval to find an information fragment that is most similar to the user problem or the user request;
(S4) processing the information fragment as required to obtained a processed information fragment as context information of the user problem or the user request; and
(S5) transmitting the context information and problem information to the LLM for processing according to interface usage method or requirements of the LLM;
wherein a sequential order of steps (S1) and (S2) is not limited.

In a second aspect, this application provides a human-artificial intelligence (AI) interaction system based on LLM, comprising:
a pre-managing module;
a problem preprocessing module;
a retrieval module;
an information fragment processing module; and
a transmitting module;
wherein the pre-managing module is configured to perform pre-management on domain-specific information, wherein the domain-specific information is not covered by training data of the LLM;
the problem preprocessing module is configured to preprocess a user question or a user request when receiving the user problem or the user request, wherein the user problem or the user request refers to a user problem or a user request without context-before information;
the retrieval module is configured to add the domain-specific information to a retrieval scope for retrieval to find an information fragment that is most similar to the user problem or the user request;
the information fragment processing module is configured to process the information fragment as required to obtained a processed information fragment as context information of the user problem or the user request; and
the transmitting module is configured to transmit the context information and problem information to the LLM for processing according to a LLM interface usage method or requirements.

One or more technical solutions provided in the embodiments of the present disclosure have at least the following technical effects or advantages.

Information not involved in training data is supplemented for the LLM through the pre-management of domain-specific information and addition of the domain-specific information to the retrieval scope for retrieval, which automatically supplements contextual information for the user problem or the user request, solving the problems such as long context limitation, timeliness and limitations of model data, and cold start, rendering the LLM suitable for more specific use scenarios. By using the pre-information management, problem preprocessing, information retrieval, and automatic splicing, it is easy to realize the productization of LLMs, and satisfy the application requirements in special use scenarios such as intelligent customer service (including questioning and answering (Q&A) robots and marketing robots), online document editing assistants, and software intelligent assistants. Based on the pre-information management, the situation of multiple rounds of supplementary input of the context by the user can be alleviated, which avoids the trouble of manual entry of the context by the user to a certain extent, and improves the user favorability. Moreover, for a chargeable LLM, it can also reduce the number of visits to a certain extent and thus reduce the usage cost.

The above description is only an overview of the technical solution of the present disclosure. To understand the technical solutions of the present disclosure more clearly to make the present disclosure can be implemented in accordance with the specification, and to make the above and other objective, characteristics and advantages of the present disclosure more obvious and understandable, the specific embodiments of the present disclosure are listed below.

### BRIEF DESCRIPTION OF THE DRAWINGS

The present application will be described in detail with reference to the accompanying drawings and specific embodiments.

FIG. 1 is a flow chart of a human-artificial intelligence (AI) interaction method based on large language model (LLM) according to an embodiment of the present disclosure; and

FIG. 2 is a structural diagram of a human-AI interaction system based on LLM according to an embodiment of the present disclosure

### DETAILED DESCRIPTION OF EMBODIMENTS

The present disclosure provides a human-artificial intelligence (AI) interaction method and system based on large language model (LLM). By using this, when the training data of the LLM does not involve domain-specific information, the relevant context information (also called auxiliary information) can be automatically supplemented for the user, and the context information and the problem information are transmitted to the LLM line for use, so as to solve the problems such as long context limitation, timeliness and limitations of model data, and the cold start.

The general idea of the technical solutions in the embodiments of the present application is as follows. Pre-management is performed on domain-specific information. Each user question or user request is pre-processed. Automatic retrieval is performed on public data, semi-public data, private domain data, or a combination thereof to find the information fragment that is most similar to the user problem or the user request. The retrieved information fragments are directly processed or reprocessed or combined as contextual information. The context information and the problem information are transmitted to the LLM for processing, so as to solve the problems, such as long context limitations, timeliness and limitations of model data, and cold starts.

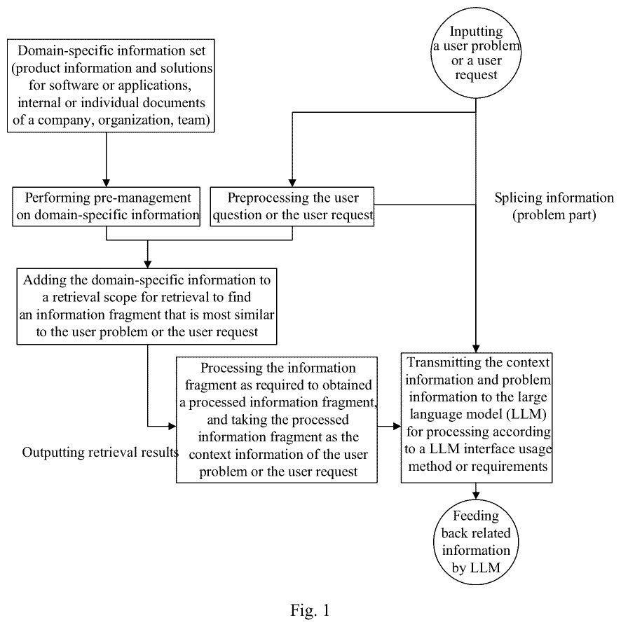

As shown in FIG. 1, this application provides a human-artificial intelligence (AI) interaction method based on LLM, which included the following steps.

(S1) Pre-management is performed on domain-specific information, where the domain-specific information is not covered by training data of the LLM, and includes but not limited to the followings.

(i) Product information and product solutions of software or applications.

(ii) Commodity or product information and solutions.

(iii) Internal documentation based on an organization (business, team) or individual.

(iv) Information and documentation information that can only be unlocked by paying for the software or product.

Because the above information is not publicly available, it will not be used as LLM training data. Therefore, the LLM will not be able to retrieve these data during use.

The pre-management includes the following steps. The domain-specific information is pre-processed, and managed using a dataset constructed by a non-vector database, or managed using a dataset constructed by a vector database, or managed using a self-developed information search or a third-party information search.

(S2) When receiving a user problem or a user request, the user question or the user request is preprocessed, where the user problem or the user request refers to a user problem or a user request without context-before information.

(S3) The domain-specific information is added to a retrieval scope for retrieval to find an information fragment that is most similar to the user problem or the user request. After adding the domain-specific information the retrieval scope, the retrieval scope includes the domain-specific information, but not excludes the original public data and semi-public data.

(S4) The information fragment is processed as required to obtained a processed information fragment as context information of the user problem or the user request.

(S5) The context information and problem information are transmitted to the LLM for processing according to interface usage method or requirements of the LLM.

A sequential order of steps (S1) and (S2) is not limited herein.

In an embodiment, in step (S4), the information fragment is processed through a direct processing approach and/or a reprocessing approach, where the reprocessing approach is selected from the group consisting of copying, editing, summarization, sorting, screening, translation, compression, filter, re-encoding, re-retrieving, multiple re-retrieving, code execution based on a retrieval result, and a combination thereof.

In an embodiment, in step (S4), the processed information fragment is used as data required by a future LLM interface.

In an embodiment, in step (S5), the transmitting of the context information and the problem information includes the following steps. The context information and the problem information are combined and spliced followed by transmission; or the context information and the problem information are respectively transmitted through independent interfaces; or the context information and the problem information are encrypted followed by transmission.

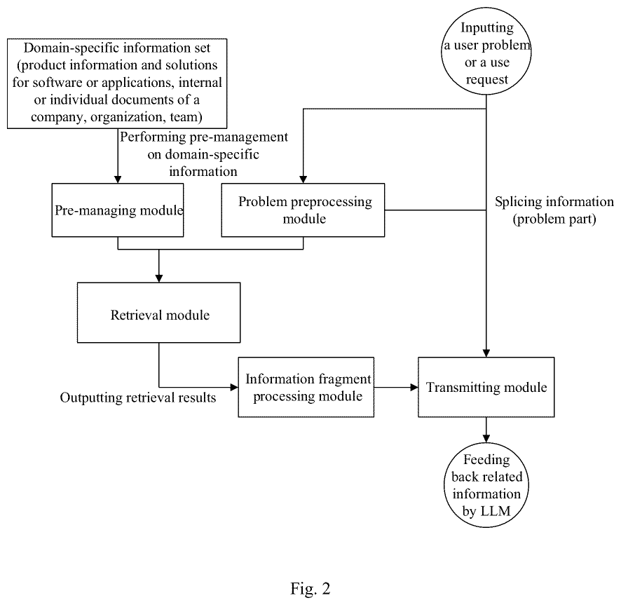

Based on the same inventive idea, this application also provides a human-AI interaction system, as shown in FIG. 2, which includes a pre-managing module, a problem preprocessing module, a retrieval module, an information fragment processing module and a transmitting module.

The pre-managing module is configured to perform pre-management on domain-specific information, wherein the domain-specific information is not covered by training data of the LLM.

The problem preprocessing module is configured to preprocess a user question or a user request when receiving the user problem or the user request, where the user problem or the user request refers to a user problem or a user request without context-before information.

The retrieval module is configured to add the domain-specific information to a retrieval scope for retrieval to find an information fragment that is most similar to the user problem or the user request.

The information fragment processing module is configured to process the information fragment as required to obtain the processed information fragment, and take the processed information fragment as the context information of the user problem or the user request.

The transmitting module is configured to transmit the context information and problem information to the LLM for processing according to interface usage method or requirements of the LLM.

In the information fragment processing module, the information fragment is processed through a direct processing approach and/or a reprocessing approach, where the reprocessing approach is selected from the group consisting of copying, editing, summarization, sorting, screening, translation, compression, filter, re-encoding, re-retrieving, multiple re-retrieving, code execution based on a retrieval result, and a combination thereof.

In the information fragment processing module, the processed information fragment is used as data required by a future LLM interface.

In the transmitting module, the transmitting of the context information and the problem information includes the following steps. The context information and the problem information are combined and spliced followed by transmission; or the context information and the problem information are respectively transmitted through independent interfaces; or the context information and the problem information are encrypted followed by transmission.

### EMBODIMENT 1

When the pre-management is performed by a dataset constructed by a non-vector database, the human-AI interaction method includes the following steps.

(S11) The domain-specific information is pre-processed, including the following steps. A content of the domain-specific information is subjected to tokenization and parsing. A tokenization label is taken as a metadata of the content of the domain-specific information. A dataset in is construct in a format of relational data or non-relational data for management.

(S12) when receiving the user problem or the user request, tokenization and parsing are performed on the user problem or the user request, or a local storage management is performed on the user problem for phased dialogue.

(S13) The domain-specific information is added to the retrieval scope for retrieval, and indexing is performed through tokenization and keyword weight to find the information fragment that is most similar to the user problem or the user request.

(S14) The information fragment is processed as required to obtain the processed information fragment as the context information of the user problem or the user request. The information fragment is processed through a direct processing approach and/or a reprocessing approach, where the reprocessing is selected from the group consisting of copying, editing, summarization, sorting, screening, translation, compression, filter, re-encoding, re-retrieving, multiple re-retrieving, code execution based on a retrieval result, and a combination thereof.

(S15) According to the interface usage method or requirements, the context information and the problem information are combined, spliced and transmitted to LLM for processing; or the context information and the problem information are respectively transmitted to LLM through independent interfaces for processing; or the context information and the problem information are encrypted and transmitted to LLM for processing.

### EMBODIMENT 2

When the pre-management is performed by a dataset constructed by a vector database, the human-AI interaction method includes the following steps.

(S21) The domain-specific information is processed, including vectorizing the domain-specific information, and managing the domain-specific information using the vector database.

(S22) When receiving the user problem or the user request, the user problem or the user request is vectorized, or a local storage management is performed on the user problem.

(S23) The domain-specific information is added to the retrieval scope for retrieval, and indexing is performed through embedding to find the information fragment that is most similar to the user problem or the user request.

(S24) The information fragment is processed as required to obtain the processed information fragment as the context information of the user problem or the user request. The information fragment is processed through a direct processing approach and/or a reprocessing approach, where the reprocessing approach is selected from the group consisting of copying, editing, summarization, sorting, screening, translation, compression, filter, re-encoding, re-retrieving, multiple re-retrieving, code execution based on a retrieval result, and a combination thereof.

(S25) According to interface usage method or requirements of the LLM, the context information and the problem information are combined, spliced and transmitted to LLM for processing; or the context information and the problem information are respectively transmitted to LLM through independent interfaces for processing; or the context information and the problem information are encrypted and transmitted to LLM for processing.

### EMBODIMENT 3

When the pre-management is performed based on a third-party pre-information management, the human-AI interaction method includes the following steps.

(S31) The domain-specific information is managed based on a self-developed information search or a third-party information search.

(S32) when receiving the user problem or the user request, the user problem or the user request is preprocessed based on requirements of the self-developed information search or the third-party information search, where the preprocessing includes no processing, word tokenization processing, keywords extraction or local storage management of the user problem.

(S33) The domain-specific information is added to the retrieval scope for retrieval using the self-developed information search or the third-party information search to find the information fragment that is most similar to the user problem or the user request.

(S34) The information fragment is processed as required to obtain the processed information fragment as the context information of the user problem or the user request. The information fragment is processed through a direct processing approach and/or a reprocessing approach, where the reprocessing approach is selected from the group consisting of copying, editing, summarization, sorting, screening, translation, compression, filter, re-encoding, re-retrieving, multiple re-retrieving, code execution based on a retrieval result, and a combination thereof.

(S35) According to the LLM interface usage method or requirements, the context information and the problem information are combined, spliced and transmitted to LLM for processing; or the context information and the problem information are respectively transmitted to LLM through independent interfaces for processing; or the context information and the problem information are encrypted and transmitted to LLM for processing.

### EMBODIMENT 4

In a case that the pre-management is performed by a dataset constructed by a non-vector database, the human-AI interaction system includes a pre-managing module, a problem preprocessing module, a retrieval module, an information fragment processing module, and a transmitting module.

The pre-managing module is configured to pre-process the domain-specific information, including: subjecting a content of the domain-specific information to tokenization and parsing; taking a tokenization label as a metadata of the content of the domain-specific information; and constructing the dataset in a format of relational data or non-relational data for management.

The problem preprocessing module is configured to perform tokenization and parsing on the user problem or the user request when receiving the user problem or the user request, or perform a local storage management of the user problem.

The retrieval module is configured to add the domain-specific information to the retrieval scope and index through tokenization and keyword weight to find the information fragment that is most similar to the user problem or the user request.

The information fragment processing module is configured to process the information fragment as required to obtain the processed information fragment as the context information of the user problem or the user request.

The transmitting module, according to the interface usage method or requirements of the LLM, is configured to combine and splice the context information and the problem information followed by transmission to the LLM for processing; or respectively transmit the context information and the problem information through independent interfaces to the LLM for processing; or encrypt the context information and the problem information followed by transmission to the LLM for processing.

### EMBODIMENT 5

In a case that the pre-management is performed by a dataset constructed by a vector database, the human-AI interaction system includes a pre-managing module, a problem preprocessing module, a retrieval module, an information fragment processing module, and a transmitting module.

The pre-managing module is configured to pre-process the domain-specific information through steps of: vectorizing the domain-specific information; and managing the domain-specific information using the vector database.

The problem preprocessing module is configured to vectorize the user problem or the user request when receiving the user problem or the user request, or perform a local storage management of the user problem.

The retrieval module is configured to add the domain-specific information to the retrieval scope and index through embedding to find the information fragment that is most similar to the user problem or the user request.

The information fragment processing module is configured to process the information fragment as required to obtain the processed information fragment as the context information of the user problem or the user request. The information fragment is processed through direct processing approach and/or reprocessing approach, where the reprocessing approach is selected from the group consisting of copying, editing, summarization, sorting, screening, translation, compression, filter, re-encoding, re-retrieving, multiple re-retrieving, code execution based on a retrieval result, and a combination thereof.

The transmitting module, according to interface usage method or requirements of the LLM, is configured to combine and splice the context information and the problem information followed by transmitting to the LLM for processing; or respectively transmit the context information and the problem information through independent interfaces to the LLM for processing; or encrypt the context information and the problem information followed by transmitting to the LLM for processing.

### EMBODIMENT 6

In a case that the pre-management is performed based on a third-party pre-information management, the human-intelligent interaction system includes a pre-managing module, a problem preprocessing module, a retrieval module, an information fragment processing module, and a transmitting module.

The pre-managing module is configured to manage the domain-specific information based on a self-developed information search or a third-party information search.

The problem preprocessing module is configured to preprocess the user problem or the user request based on requirements of the self-developed information search or the third-party information search when receiving the user problem or the user request, where the preprocessing includes no processing, word tokenization processing, keywords extraction or local storage management of the user problem.

The retrieval module is configured to add the domain-specific information to the retrieval scope for retrieval using the self-developed information search or the third-party information search to find the information fragment that is most similar to the user problem or the user request.

The information fragment processing module is configured to process the information fragment as required to obtain the processed information fragment as the context information of the user problem or the user request. The information fragment is processed through a direct processing approach and/or a reprocessing approach, where the reprocessing approach is selected from the group consisting of copying, editing, summarization, sorting, screening, translation, compression, filter, re-encoding or re-retrieving or multiple re-retrieving, code execution based on a retrieval result, and a combination thereof.

The transmitting module, according to the interface usage method or requirements of the LLM, is configured to combine and splice the context information and the problem information followed by transmitting to the LLM for processing; or respectively transmit the context information and the problem information through independent interfaces to the LLM for processing; or encrypt the context information and the problem information followed by transmitting to the LLM for processing.

Since the system introduced in Embodiments 4-6 of the present disclosure is the device used to implement the methods of Embodiments 1-3 of the present disclosure, based on the methods provided in Embodiments 1-3 of the present disclosure, one of ordinary skill in the art can understand the specific structure and deformation of the device, so it is not repeated here. All devices used in the methods of Embodiments 1-3 of the present disclosure fall in the scope of protection intended by the present disclosure.

Compared with the prior art, the present disclosure has at least the following beneficial effects.

Information not involved in training data is supplemented for the LLM through the pre-management of domain-specific information and addition of the domain-specific information to the retrieval scope for retrieval, which automatically supplements contextual information for the user problem or the user request, solving the problems such as long context limitation, timeliness and limitations of model data, and cold start, rendering the LLM suitable for more specific use scenarios. By using the pre-information management, problem preprocessing, information retrieval, and automatic splicing, it is easy to realize the productization of LLMs, and satisfy the application requirements in special use scenarios such as intelligent customer service (including questioning and answering (Q&A) robots and marketing robots), online document editing assistants, and software intelligent assistants. Based on the pre-information management, the situation of multiple rounds of supplementary input of the context by the user can be alleviated, which avoids the trouble of manual entry of the context by the user to a certain extent, and improves the user favorability. Moreover, for a chargeable LLM, it can also reduce the number of visits to a certain extent and thus reduce the usage cost.

Although specific embodiments of the present disclosure have been described above, one of ordinary skill in the art should understand that the described embodiments are merely illustrative and are not intended to limit the scope of the present disclosure. Various modifications and variations made by one of ordinary skill in the art without departing from the spirit of the present disclosure should fall within the scope of the present disclosure defined by the appended claims.

What is claimed is:

1. A human-artificial intelligence (AI) interaction method based on large language model (LLM), comprising:
(S1) performing pre-management on domain-specific information, wherein the domain-specific information is not covered by training data of the LLM;
(S2) when receiving a user problem or a user request, preprocessing the user question or the user request, wherein the user problem or the user request refers to a user problem or a user request without context-before information;
(S3) adding the domain-specific information to a retrieval scope for retrieval to find an information fragment that is most similar to the user problem or the user request;
(S4) processing the information fragment as required to obtain a processed information fragment as context information of the user problem or the user request; and
(S5) transmitting the context information and problem information to the LLM for processing according to interface usage method or requirements of the LLM;
wherein a sequential order of steps (S1) and (S2) is not limited.

2. The human-AI interaction method of claim 1, wherein in step (S4), the information fragment is processed through a direct processing approach and/or a reprocessing approach, wherein the reprocessing approach is selected from the group consisting of copying, editing, summarization, sorting, screening, translation, compression, filter, re-encoding, re-retrieving, multiple re-retrieving, code execution based on a retrieval result, and a combination thereof;
in step (S4), the processed information fragment is also used as data required by a future LLM interface; and
in step (S5), the transmitting of the context information and the problem information comprises:
combining and splicing the context information and the problem information followed by transmission;
respectively transmitting the context information and the problem information through independent interfaces; or
encrypting the context information and the problem information followed by transmission.

3. The human-AI interaction method of claim 1, wherein when the pre-management is performed by constructing a dataset by using a non-vector database, the human-AI interaction method comprises:
(S11) pre-processing the domain-specific information, comprising:
subjecting a content of the domain-specific information to tokenization and parsing;
taking a tokenization label as a metadata of the content of the domain-specific information; and
constructing the dataset in a format of relational data or non-relational data for management;
(S12) when receiving the user problem or the user request, performing tokenization and parsing on the user problem or the user request, or performing, by a local, storage management on the user problem;
(S13) adding the domain-specific information to the retrieval scope for retrieval, and performing indexing through tokenization and keyword weight to find the information fragment that is most similar to the user problem or the user request;
(S14) processing the information fragment as required to obtain the processed information fragment as the context information of the user problem or the user request; and
(S15) according to the interface usage method or requirements of the LLM, combining and splicing the context information and the problem information followed by transmitting to the LLM for processing;
respectively transmitting the context information and the problem information through independent interfaces to the LLM for processing; or
encrypting the context information and the problem information followed by transmitting to the LLM for processing.

4. The human-AI interaction method of claim 1, wherein when the pre-management is performed by constructing a dataset using a vector database, the human-AI interaction method comprises:
(S21) pre-processing the domain-specific information, comprising:
vectorizing the domain-specific information; and
managing the domain-specific information using the vector database;
(S22) when receiving the user problem or the user request, vectorizing the user problem or the user request, or performing a local storage management on the user problem;
(S23) adding the domain-specific information to the retrieval scope for retrieval, and indexing through embedding to find the information fragment that is most similar to the user problem or the user request;
(S24) processing the information fragment as required to obtain the processed information fragment as the context information of the user problem or the user request; and
(S25) according to interface usage method or requirements of the LLM, combining and splicing the context information and the problem information followed by transmitting to the LLM for processing; or
respectively transmitting the context information and the problem information through independent interfaces to the LLM for processing; or
encrypting the context information and the problem information followed by transmitting to the LLM for processing.

5. The human-AI interaction method of claim 1, wherein when the pre-management is based on a third-party pre-information management, the human-intelligent interaction method comprises:
(S31) managing the domain-specific information based on a self-developed information search or a third-party information search;
(S32) when receiving the user problem or the user request, preprocessing the user problem or the user request based on requirements of the self-developed information search or the third-party information search, wherein the preprocessing comprises no processing, word tokenization processing, keywords extraction or local storage management of the user problem;
(S33) adding the domain-specific information to the retrieval scope for retrieval using the self-developed information search or the third-party information search to find the information fragment that is most similar to the user problem or the user request;
(S34) processing the information fragment as required to obtain the processed information fragment as the context information of the user problem or the user request; and
(S35) according to the LLM interface usage method or requirements, combining and splicing the context information and the problem information followed by transmitting to the LLM for processing; or
respectively transmitting the context information and the problem information through independent interfaces to the LLM for processing; or
encrypting the context information and the problem information followed by transmitting to the LLM for processing.

6. A human-artificial intelligence (AI) interaction system, comprising:
a pre-managing module;
a problem preprocessing module;
a retrieval module;
an information fragment processing module; and
a transmitting module;
wherein the pre-managing module is configured to perform pre-management on domain-specific information, wherein the domain-specific information is not covered by training data of the LLM;
the problem preprocessing module is configured to preprocess a user question or a user request when receiving the user problem or the user request, wherein the user problem or the user request refers to a user problem or a user request without context-before information;
the retrieval module is configured to add the domain-specific information to a retrieval scope for retrieval to find an information fragment that is most similar to the user problem or the user request;
the information fragment processing module is configured to process the information fragment as required to obtained a processed information fragment as context information of the user problem or the user request; and
the transmitting module is configured to transmit the context information and problem information to the LLM for processing according to interface usage method or requirements of the LLM.

7. The human-AI interaction system of claim 6, wherein the information fragment processing module is configured to process the information fragment through a direct processing approach and/or a reprocessing approach, and take the processed information fragment as data required by a future LLM interface, wherein the reprocessing approach is selected from the group consisting of copying, editing, summarization, sorting, screening, translation, compression, filter, re-encoding, re-retrieving, multiple re-retrieving, code execution based on a retrieval result, and a combination thereof; and
the transmitting module is configured to transmit the context information and the problem information through a step of:
combining and splicing the context information and the problem information followed by transmitting;
respectively transmitting the context information and the problem information through independent interfaces; or
encrypting the context information and the problem information followed by transmitting.

8. The human-AI interaction system of claim 6, wherein in a case that the pre-management is performed by a dataset constructed by a non-vector database, the pre-managing module is configured to pre-process the domain-specific information through steps of:
parsing a word tokenization of an information content;
taking a word tokenization label as a metadata of the information content; and
constructing a dataset in a format of relational data or non-relational data for management;
the problem preprocessing module is configured to perform a word tokenization parsing on the user problem or the user request when receiving the user problem or the user request, or perform a local storage management of the user problem;
the retrieval module is configured to add the domain-specific information to the retrieval scope for retrieval, and index through a word tokenization weight keyword to find the information fragment that is most similar to the user problem or the user request;
the information fragment processing module is configured to process the information fragment as required to obtain the processed information fragment, and take the processed information fragment as the context information of the user problem or the user request; and
the transmitting module, according to the LLM interface usage method or requirements, is configured to combine and splice the context information and the problem information followed by transmitting to the LLM for processing; or
respectively transmit the context information and the problem information through independent interfaces to the LLM for processing; or
encrypt the context information and the problem information followed by transmitting to the LLM for processing.

9. The human-AI interaction system of claim 6, wherein in a case that the pre-management is performed by a dataset constructed by a vector database for management, the pre-managing module is configured to pre-process the domain-specific information through steps of:
vectorizing the domain-specific information; and
managing the domain-specific information using the vector database;
the problem preprocessing module is configured to vectorize the user problem or the user request when receiving the user problem or the user request, or perform a local storage management of the user problem;
the retrieval module is configured to add the domain-specific information to the retrieval scope for retrieval, and index through embedding to find the information fragment that is most similar to the user problem or the user request;
the information fragment processing module is configured to process the information fragment as required to obtain the processed information fragment, and take the processed information fragment as the context information of the user problem or the user request; and
the transmitting module, according to the LLM interface usage method or requirements, is configured to combine and splice the context information and the problem information followed by transmitting to the LLM for processing; or
respectively transmit the context information and the problem information through independent interfaces to the LLM for processing; or
encrypt the context information and the problem information followed by transmitting to the LLM for processing.

10. The human-AI interaction system of claim 6, wherein in a case that the pre-management is based on a third-party pre-information management, the pre-managing module is configured to manage the domain-specific information based on a self-developed information search or a third-party information search;
the problem preprocessing module is configured to preprocess the user problem or the user request based on requirements of the self-developed information search or the third-party information search when receiving the user problem or the user request, wherein the preprocessing comprises no processing, word tokenization processing, keywords extraction or local storage management of the user problem;
the retrieval module is configured to add the domain-specific information to the retrieval scope for retrieval using the self-developed information search or the third-party information search to find the information fragment that is most similar to the user problem or the user request;
the information fragment processing module is configured to process the information fragment as required to obtain the processed information fragment, and take the processed information fragment as the context information of the user problem or the user request; and
the transmitting module, according to the LLM interface usage method or requirements, is configured to combine and splice the context information and the problem information followed by transmitting to the LLM for processing; or
respectively transmit the context information and the problem information through independent interfaces to the LLM for processing; or
encrypt the context information and the problem information followed by transmitting to the LLM for processing.
